(19) United States
(12) Patent Application Publication
(10) Pub. No.: US 2007/0045176 A1
(43) Pub. Date: Mar. 1, 2007

(54) Antimicrobial filter with metallic threads

(75) Inventors: N. Satish Chandra, Lansdale, PA (US); William F. McNally, Clarks Summit, PA (US); Joel M. Furey, Stowe, VT (US)

Correspondence Address: AKERMAN SENTERFITT, P.O. BOX 3188, WEST PALM BEACH, FL, 33402-3188, US

(73) Assignee: Noble Fiber Technologies, LLC, Scranton, PA (US)

(21) Appl. No.: 11/508,675

(22) Filed: Aug. 23, 2006

Related U.S. Application Data
(60) Provisional application No. 60/710,567, filed on Aug. 23, 2005.

(51) Int. Cl. C02F 1/50

(52) U.S. Cl. 210/501

(57) ABSTRACT

A filter membrane formed from a filter medium and one or more metallic threads incorporated with the filter membrane for antimicrobial properties. The metallic threads may be formed from silver, copper, and zinc. The metallic threads may be wrapped around or incorporated within the material forming the filter membrane. In one embodiment, the metallic thread may be wrapped around the outside of a cartridge style filter body to kill bacteria and other organisms from the air or fluid, such as water, flowing through the filter.

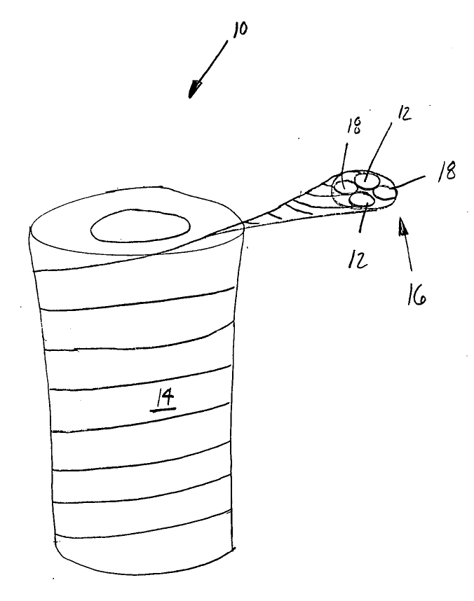

### CROSS REFERENCE TO RELATED APPLICATIONS

This application claims the benefit of United States Provisional Patent Application No. 60/710,567, filed Aug. 23, 2005.

### FIELD OF THE INVENTION

This invention is directed generally to filters, and more particularly to antimicrobial filters.

### BACKGROUND

Conventional filters are typically formed with very small openings to remove particles, as well as microbes, from a fluid flow. While conventional filters effectively remove particles from fluids, conventional filters do not address the problem caused by the presence of live microbes in the filter, which may be a large concentration of germs. The presence of the live microbes in the filter can threaten a person handling the spent filter and can pose other health hazards. Thus, a need exists for filter that effectively removes microbes and eliminates the health hazards caused by microbes in a filter.

### SUMMARY OF THE INVENTION

This invention is directed to a filter that includes one or more metallic threads for antimicrobial properties. The metallic threads may be incorporated into the material forming the filter, may be attached to an outer surface of the filter, such as being wrapped around an outer surface of the filter, or may be attached in another appropriate manner. The metallic threads may be formed from silver, copper, zinc or other appropriate metals. In one embodiment, one or more metallic threads may be wrapped around the outside of a cartridge style filter body to kill bacteria and other organisms from the air or fluid, such as water, flowing through the filter. The filter not only stops the microbes from passing through the filter but also effectively kills the microbes trapped in the filter. The action starts immediately, and within a very short time, the ionic silver kills substantially all, if not all, of the microbes. The ionic silver may also enter the fluids flowing through the filter, such as into water in a pool filter system, and may kill any microbes in the pool water.

The filter may be formed from one or more pieces of filter material. The filter may also include one or more silver threads attached to the filter material to kill bacteria and other organisms with the filter. The silver thread may be attached to an outer surface of the filter or incorporated within the at least one piece of filter material, or both. The silver thread may be formed from a silver coated nylon material. In one embodiment, the silver coated nylon material may have a length between about 0.5 inches and about 8 inches, a denier of between about 0.5 and about 50 and between about three percent silver and about 75 percent silver by weight. In another embodiment, the silver coated nylon material may have between about one filament and about 100 filaments, a denier of between about 0.5 and about 50 and between about 0.09 percent silver and about 16 percent silver by weight. In particular, the silver coated nylon material may have between about one filament and about 34 filaments, a denier of about six and about five percent silver by weight. The one silver thread may be formed from staple fibers, from a non-woven textile matrix or other materials. The silver thread may be formed from a silver fiber between about 1 and 50 percent by weight and a carrier fiber that is between about 99 and 50 percent by weight. In another embodiment, the silver thread may be formed from a silver fiber is about 40 percent by weight and a carrier fiber that is about 60 percent by weight.

In one embodiment, the filter may be formed from one or more pieces of filter material forming a cartridge filter. The cartridge filter may include one or more metallic threads wrapped around an outer surface of the cartridge filter to kill bacteria and other organisms with the filter. The metallic thread may include a metal such as silver, copper, and zinc. The metallic thread may be formed from one or more of the following combinations: copper and zinc, silver and carbon, silver and copper, and silver and zinc.

An advantage of this invention is that filters may be retrofitted to create an antimicrobial filter by wrapping one or more metallic threads around an outer surface of a cartridge style filter.

Another advantage of this invention is that a filter with one or more metallic threads exhibits outstanding antimicrobial efficacy.

Yet another advantage of this invention is that a filter with one or more metallic threads has optimal silver ion release.

These and other embodiments are described in more detail below.

### BRIEF DESCRIPTION OF THE DRAWINGS

The accompanying drawing, which is incorporated in and forms a part of the specification, illustrates an embodiment of the presently disclosed invention and, together with the description, disclose the principles of the invention. The FIGURE is a perspective view of a filter with a textile matrix formed of a metallic thread and a carrier yarn wrapped around an outer surface of the filter.

### DETAILED DESCRIPTION OF THE INVENTION

As shown in the FIGURE, the invention is directed to a filter 10 that includes one or more metallic threads 12 for antimicrobial properties. The metallic threads 12 may be incorporated into the material forming the filter 10, may be attached to an outer surface 14 of the filter 10, such as being wrapped around an outer surface of the filter 10, or may be attached in another appropriate manner. The metallic threads 12 may be formed from silver, copper, zinc or other appropriate metals. In one embodiment, one or more metallic threads 12 may be wrapped around the outside of a cartridge style filter body 10 to kill bacteria and other organisms from the air or fluid, such as water, flowing through the filter 10.

The invention is directed to a filter 10 including a textile matrix 16 having a metal such as silver for filtration applications, which includes liquid and air as media. The filter 10 exhibits excellent anti-microbial efficacy and can be used as a component material in filtration anti-microbial applications. The textile matrix 16 that may include, but is not limited to: filaments, such as flat and textured; spun yarn made from methods including but not limited to roving, drafting, ring spun, and air spun, chopped fibers as flocked material, and micronized fiber as flocked material. The textile matrix 16 may also include substrates such as, but are not limited to: nylon, polyester, acrylic, high temperature fibers such as Kevlar, PBO, rayon and other polymeric materials, cellulose and other bioabsorbable materials.

In one embodiment, the textile matrix 16 may include a bright and substantially uniform metal surface on the textile matrix 16 formed without the use of surfactants in the metallizing process. The metallized textile matrix 16 may be durable and highly adherent. The metal surface may be formed from silver in amounts between about 0.009 percent and 15 percent by weight. The filter 10 material may be made of any appropriate material with a pore size from between a sub micron size to about 500 microns.

The metallic thread 12 may be formed from silver coated fibers. The silver coated fibers may be, but are not limited to being, X-STATIC silver coated fibers, Noble Fiber LLC, Scranton, Pa. The silver coated fiber may be formed from a substrate, such as, but not limited to, nylon, coated with silver. The following table describes characteristics of the silver coated fibers (for staple):

| | | Denier | Silver |
|---|---|---|---|
| | Length | (dpf) | (% w/w) |
| Outside range | ½-8 | .5-50 | 3-75% |
| Intermediate range | ¾-6 | .7-30 | 9-60% |
| Optimal range | 1-3 | 1-10 | 12-30% |
| Ideal | ˜2 | ˜3 | ˜21 |

In another embodiment, the silver coated fibers may be created as listed below:

| | | Denier | Silver |
|---|---|---|---|
| | Filaments | (dpf) | (% w/w) |
| Outside range | 1-100 | .5-50 | 0.09-16% |
| Intermediate range | 1-75 | .7-30 | 0.9-12% |
| Optimal range | 1-68 | 1-18 | 1-10% |
| Ideal | 1-34 | ˜6 | ˜5 |

The textile matrix 16 may include additional fibers other than the silver coated fibers and absorptive fibers. For example, the filter 10 may include cotton, cellulose, polyester, acrylic, nylon, carbon and other appropriate materials. The metallic threads 12 may be formed from continuous filaments with metals that create anti-microbial properties. The following table describes the typical characteristics of the filament yarn:

| | | Denier | Silver |
|---|---|---|---|
| | Filaments | (dpf) | (% w/w) |
| Outside range | 1-100 | .5-50 | 3-75% |
| Intermediate range | 1-75 | .7-30 | 9-60% |
| Optimal range | 1-68 | 1-18 | 12-30% |
| Ideal | 1-34 | ˜6 | ˜21 |

In another embodiment, the textile matrix 16 may also include fibers coated with antibiotic metals, which may be anti-microbial, anti-bacterial, or anti-fungal, or any combination thereof. The metals include, but are not limited to, copper, zinc and carbon for adsorption purposes. In at least one embodiment, the textile matrix 16 may include silver coated fibers and copper-coated fibers. In another embodiment, the textile matrix 16 may include silver coated fibers and zinc coated fibers. In yet another embodiment, the textile matrix 16 may include silver coated fibers and carbon fibers.

The textile matrix 16 may be a non-woven textile matrix 16 formed from short fibers, such as staple or chopped fibers, to create a web, felt, fabric or rope. In at least one embodiment, the textile matrix 16 may be intimately blended. Alternatively, the textile matrix 16 may be layered. One advantage of non-woven textile matrix 16 is that it can be cut to any shape or size or spun into any size or count. In one embodiment, the silver coated fibers may be distributed three dimensionally throughout the textile matrix 16, thereby providing the antibiotic properties throughout the textile matrix 16.

In one embodiment, the metallic thread 12 may be attached to a carrier fiber 18 for support and added strength. The metallic thread 12 may be a silver coated fiber, and the carrier fiber, may be, but is not limited to being, polypropylene, polyester and other man-made and natural fibers. The table below identifies the possible configurations of the metallic thread 12 and the carrier fiber 18.

| | Silver coated Fiber | Carrier Fiber |
|---|---|---|
| | (% w/w) | (% w/w) |
| Outside Range | 1-99 | 99-1 |
| Intermediate Range | 1-60 | 99-40 |
| Optimal Range | 1-50 | 99-50 |
| Ideal | ˜40 | ˜60 |

As noted above, the textile matrix 16 may include fibers other than the absorptive fibers and silver coated fibers described above. In one embodiment, the textile matrix 16 may include a blend of silver coated fibers of about 50 percent by weight and the remaining 50 percent may be polypropylene fibers or other fibers typically used in filtration. In another embodiment, additional fibers may be added in an amount that does not eliminate the desirable antibiotic and filtration properties of the textile matrix 16. The textile matrix 16 may be twisted together with one or more metallic threads 12 to form a string that may be wrapped around the filter 10.

The desirable antibiotic properties of the textile matrix 16 may be characterized by antimicrobial efficacy, which may be determined using the Dow Corning Shake Flask Test over 24 hours or the New NY State 63 Test for Bacteriostatic Activity. The kill rate may be not less than about 70%, more preferably the kill rate may be not less than about 85%, ideally the kill rate may be not less than about 95%.

The textile matrix 16 may be formed by preparing input fiber by carding the fiber, which includes opening the silver coated fiber, blending and orienting the fiber, and cross-lapping the fiber. The process of forming the textile matrix 16 may also include needle punching the web. The metallic thread 12 may be formed by preparing the input fiber and carding the fiber, which may include opening the silver coated fiber, blending and orienting the fiber, and drawing the fiber. The process of forming the metallic thread 12 may also include roving to further condense the fiber. Each of these steps is described in detail below. Once formed, the metallic thread 12 may be blended, mixed or twisted together with a typical polypropylene fiber used in filtration products to produce a string-like material that may be a 100% blend of X-STATIC silver, or a 60/40 or 50/50 blend depending the environment and requirements.

The silver coated yarn 12 may be prepared as described in U.S. Pat. No. 4,042,737, entitled “Process for producing crimped metal-coated filamentary materials, and yarns and fabrics obtained therefrom,” issued to Rohm and Haas Company (Philadelphia, Pa.), on Aug. 16, 1977, which is incorporated by reference herein, or formed in another appropriate manner. The silver coated yarn 12 may be manufactured in the form of a continuous filament and then cut into short segments having lengths as described above. It has been discovered that cut yarn, rather than staple fiber, dramatically improve the properties of the final product. The fibers of cut yarn are significantly easier to utilize in the manufacturing process because there is less clumping (adhesion to itself) of fibers. It is believed that this improvement is facilitated by the general axial alignment of the fibers after the yarn is cut relative to the random orientation of the fibers that results from coating staple fibers. Manufacturing the short fibers from long fibers after aqueous processing also helps prevent clumping, as opposed to processing short (staple) fibers and allowing them to dry together.

The fibers may be carded using a traditional carding process. A preferred carding machine is the Bematic card, manufactured by Bettarini & Serafini S.r.l. (Prato, Italy). Carding blends the fibers together and orients them in generally the same direction, i.e., generally parallel. Carding may include the following steps.

The silver coated fiber 12 may be opened. When the silver coated fiber 12 is processed wet and subsequently dried, the silver coated fiber 12 clumps together (though not to the same extent as staple fiber that is processed and then dried). During the opening process, the silver coated fiber 12 is opened, typically twice, as needed, to separate the individual staple fibers from each other to enable it to be blended with the carrier yarn 18.

The silver coated fiber 12 and the carrier fiber 18 may then blended and oriented to create a web. The fibers 12, 18 may be cross-lapped, typically about eight or nine times, to provide substance and rigidity to the web and to optimize surface area of the silver coated fibers 12. The combined fibers 12, 18 may be needle-punched to form the final output textile matrix 16. The final output textile 16 may be drawn to create a silver having filtration and antibiotic fibers. The final output textile 16 may undergo a roving process to further condense the fiber.

Once formed, the textile matrix 16 of the invention is useful in any context in which the characteristics of absorption and anti-microbial activity are desirable. The textile matrix 16 is especially useful to facilitate an environment conducive to preventing bacterial growth in a filter 10. Filters 10 incorporating the textile matrix 16 may be manufactured using a wide variety of useful designs that may be new or conventional. The textile matrix 16 o is capable of killing microbes without releasing a significant amount of elemental silver into the environment but rather releasing ionic silver in response to stimuli. Filters 10 incorporating the textile matrix 12 of the invention retain antibiotic activity for extended periods of time due to even and sustained release of ionic silver.

### EXAMPLE 1

Three textile matrix samples were manufactured according to the foregoing procedure with varying amounts of silver/carrier fibers (90/10). The matrix was tested for anti-microbial activity using the Dow Corning Corporate Test Method 0923 for all examples.

Organism Count (CFU/ml)

| Sample Identification | “0” Time | 1-Hour | Percent Reduction |
|---|---|---|---|
| Filter with Silver | 18,000 | <10 | 99.9 |
| Control (No silver) | 16,000 | 19,000 | No Reduction |

### EXAMPLE 2

Three textile matrix samples were manufactured according to the foregoing procedure with varying amounts of silver/carrier fibers (60/40).

Organism Count (CFU/ml)

| Sample Identification | “0” Time | 1-Hour | Percent Reduction |
|---|---|---|---|
| Filter with Silver | 18,000 | <10 | 99.9 |
| Control (No silver) | 16,000 | 19,000 | No Reduction |

### EXAMPLE 3

Three textile matrix samples were manufactured according to the foregoing procedure with varying amounts of silver/carrier fibers (40/60).

Organism Count (CFU/ml)

| Sample Identification | “0” Time | 1-Hour | Percent Reduction |
|---|---|---|---|
| Filter with Silver | 18,000 | <10 | 99.9 |
| Control (No silver) | 16,000 | 19,000 | No Reduction |

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A filter, comprising:
at least one piece of filter material;
at least one silver thread attached to the filter material to kill bacteria and other organisms with the filter.

2. The filter of claim 1, wherein the at least one silver thread is attached to an outer surface of the filter.

3. The filter of claim 1, wherein the at least one silver thread is incorporated within the at least one piece of filter material.

4. The filter of claim 1, wherein the at least one silver thread is formed from a silver coated nylon material.

5. The filter of claim 4, wherein the silver coated nylon material has a length between about 0.5 inches and about 8 inches, a denier of between about 0.5 and about 50 and between about three percent silver and about 75 percent silver by weight.

6. The filter of claim 4, wherein the silver coated nylon material has between about one filament and about 100 filaments, a denier of between about 0.5 and about 50 and between about 0.09 percent silver and about 16 percent silver by weight.

7. The filter of claim 6, wherein the silver coated nylon material has between about one filament and about 34 filaments, a denier of about six and about five percent silver by weight.

8. The filter of claim 1, wherein the at least one silver thread is formed from staple fibers.

9. The filter of claim 1, wherein the at least one silver thread is formed from a non-woven textile matrix.

10. The filter of claim 1, wherein the at least one silver thread is formed from a silver fiber between about 1 and 50 percent by weight and a carrier fiber that is between about 99 and 50 percent by weight.

11. The filter of claim 10, wherein the at least one silver thread is formed from a silver fiber is about 40 percent by weight and a carrier fiber that is about 60 percent by weight.

12. A filter, comprising:
at least one piece of filter material forming a cartridge filter;
at least one metallic thread wrapped around an outer surface of the cartridge filter to kill bacteria and other organisms with the filter.

13. The filter of claim 12, wherein the at least one metallic thread comprises a metal selected from the group consisting of silver, copper, and zinc.

14. The filter of claim 13, wherein the at least one metallic thread comprises a thread formed from copper and zinc.

15. The filter of claim 13, wherein the at least one metallic thread comprises a thread formed from silver and carbon.

16. The filter of claim 13, wherein the at least one metallic thread comprises a thread formed from silver and copper.

17. The filter of claim 13, wherein the at least one metallic thread comprises a thread formed from silver and zinc.
